(19) United States
(12) Patent Application Publication
(10) Pub. No.: US 2012/0274845 A1
(43) Pub. Date: Nov. 1, 2012

(54) IMAGE PROCESSING DEVICE AND METHOD, AND PROGRAM

(75) Inventor: Takuto MOTOYAMA, Tokyo (JP)

(73) Assignee: Sony Corporation, Tokyo (JP)

(21) Appl. No.: 13/442,084

(22) Filed: Apr. 9, 2012

(30) Foreign Application Priority Data
Apr. 26, 2011 (JP) 2011-098391

(51) Int. Cl. H04N 7/01

(52) U.S. Cl. 348/441

(57) ABSTRACT

A pull-down pattern detection portion detects a pull-down pattern in an input image on which pull-down has been performed. Based on the pull-down pattern and on a first frame frequency that is a frame frequency of the input image, a frame frequency calculation portion calculates a second frame frequency that is a frame frequency of an original image before the pull-down has been performed on the input image. The present technology can be applied to an image processing device that performs frame rate conversion of the input image on which pull-down processing has been performed using a predetermined pull-down pattern.

### BACKGROUND

The present technology relates to an image processing device and method, and a program, and particularly to an image processing device and method, and a program that make it possible to estimate a frame frequency before pull-down, for an input image of a given pull-down pattern.

In recent years, many image signals at various frame frequencies are present.

For example, while the frame frequency of a movie's original image is 24 Hz, the frame frequency of an original image of computer graphics is 30 Hz. Further, the frame frequency of broadcast images differs depending on the country. For example, while the frame frequency of images broadcast in Japan is 60 Hz, the frame frequency of images broadcast in Europe is 50 Hz. Further, a variety of frame frequencies are used for video content on the Internet, which is increasing rapidly in recent years.

In this way, when images with different frame frequencies are broadcast by digital television broadcast, the images are broadcast after the frame frequencies are unified by a broadcast station. For example, when a movie's original image with a frame frequency of 24 Hz is broadcast at a frame frequency of 60 Hz, 3-2 pull-down processing is performed by the broadcast station. When an image with a frame frequency of 30 Hz is broadcast at a frame frequency of 60 Hz, 2-2 pull-down processing is performed by the broadcast station.

Here, as shown in FIG. 1, the 3-2 pull-down processing is processing that converts the frame frequency (the frame rate) of 24 Hz to 60 Hz by repeating the following processing: a first frame image of a movie whose frame frequency is 24 Hz, for example, is used for first, second and third fields of a television image whose frame frequency is 60 Hz; a second frame image of the movie is used for fourth and fifth fields of the television image; a third frame image of the movie is used for sixth, seventh and eighth fields of the television image; and a fourth frame image of the movie is used for ninth and tenth fields of the television image. Note that pull-down patterns other than a 3-2 pull-down pattern and a 2-2 pull-down pattern exist for the pull-down processing.

However, when the images, on which the pull-down processing has been performed in this way, are displayed on a screen of a television receiver or the like, judder is perceived by a viewer in a motion scene, for example, and the motion appears unnatural.

FIG. 2 shows frame phase comparison between: an image which has undergone the 3-2 pull-down processing such that the frame frequency of an input image to the television receiver or the like is 60 Hz; and an original image whose frame frequency is 60 Hz. The upper graph of FIG. 2 shows a frame phase, with respect to time (clock time), of the image which has undergone the 3-2 pull-down processing. The lower graph of FIG. 2 shows a frame phase of the original image with respect to time. As shown in FIG. 2, for the original image, each frame is output sequentially with respect to time. Meanwhile, for the image which has undergone the 3-2 pull-down processing, frames in a same phase with respect to time are output such that three frames are output and then two frames are output. In other words, the image which has undergone the 3-2 pull-down processing is not a smooth image when it is displayed on the screen.

To address this, a technique to reduce the above-described judder is proposed (refer to Japanese Patent Application Publication No. JP-A-2010-11108, for example). In this technique, when converting the frame rate of the image on which the pull-down processing has been performed, specific pull-down patterns, such as the 3-2 pull-down pattern and the 2-2 pull-down pattern, are detected. Then, the image is corrected in accordance with a detection result and frame interpolation is performed.

### SUMMARY

However, with the above-described technique, pull-down patterns other than the 3-2 pull-down pattern and the 2-2 pull-down pattern cannot be detected. Therefore, it is not possible to estimate the frame frequency before the pull-down has been performed.

Further, if currently existing pull-down patterns are all held in a table, it is possible to detect the pull-down patterns other than the 3-2 pull-down pattern and the 2-2 pull-down pattern. However, in this case, it is necessary to perform processing for all the pull-down patterns, resulting in complicated control as well as an increased cost. In addition, since it is not possible to respond to pull-down patterns that do not currently exist, future scalability is low.

The present technology has been made in light of the foregoing circumstances, and makes it possible to estimate a frame frequency before pull-down, for an input image of a given pull-down pattern.

According to an embodiment of the present disclosure, there is provided an image processing device which includes a pull-down pattern detection portion that detects a pull-down pattern in an input image on which pull-down has been performed, and a frame frequency calculation portion that calculates, based on the pull-down pattern and on a first frame frequency that is a frame frequency of the input image, a second frame frequency that is a frame frequency of an original image before the pull-down has been performed on the input image.

The image processing device can make the pull-down pattern detection portion detect, based on a pattern of existence and non-existence of motion between frames of the input image, a pull-down cycle that is a frame cycle in which the pull-down pattern is repeated, and count a number of the frames that represents a number of motions between the frames in the pull-down cycle. The image processing device can make the frame frequency calculation portion calculate the second frame frequency based on the pull-down cycle, the number of motion frames and the first frame frequency.

The image processing device can further include a motion vector detection portion that detects a motion vector between frames of the original image, and a motion compensation portion that performs motion compensation based on the motion vector, the second frame frequency and a third frame frequency that is a frame frequency of an output image, and generates an interpolated frame of the original image.

The image processing device can further include an interpolation phase determination portion that calculates, based on the second frame frequency and the third frame frequency, an interpolation phase that represents a time position of the interpolated frame between the frames of the original image. The image processing device can make the motion compensation portion generate the interpolated frame using the interpolation phase between the frames of the original image.

According to an embodiment of the present disclosure, there is provided an image processing method which includes detecting a pull-down pattern in an input image on which pull-down has been performed, and calculating, based on the pull-down pattern and on a first frame frequency that is a frame frequency of the input image, a second frame frequency that is a frame frequency of an original image before the pull-down has been performed on the input image.

According to an embodiment of the present disclosure, there is provided a program which causes a computer to execute processing including detecting a pull-down pattern in an input image on which pull-down has been performed, and calculating, based on the pull-down pattern and on a first frame frequency that is a frame frequency of the input image, a second frame frequency that is a frame frequency of an original image before the pull-down has been performed on the input image.

According to an embodiment of the present disclosure, a pull-down pattern in an input image on which pull-down has been performed is detected, and a second frame frequency that is a frame frequency of an original image before the pull-down has been performed on the input image is calculated based on the pull-down pattern and on a first frame frequency that is a frame frequency of the input image.

According to an aspect of the present technology, it is possible to estimate a frame frequency before pull-down, for an input image of a given pull-down pattern.

### BRIEF DESCRIPTION OF THE DRAWINGS

FIG. 1 is a diagram illustrating 3-2 pull-down processing;

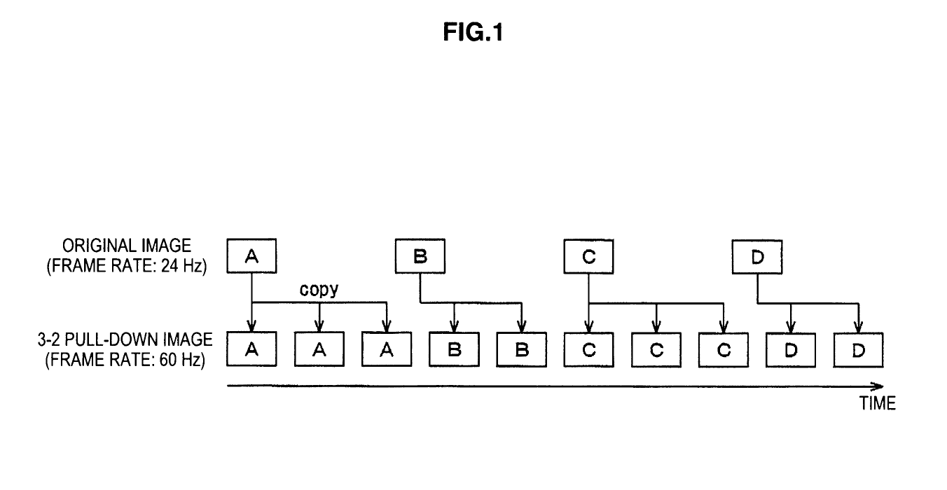

FIG. 2 is a diagram in which a frame phase of an image which has undergone the 3-2 pull-down processing is compared with a frame phase of an original image;

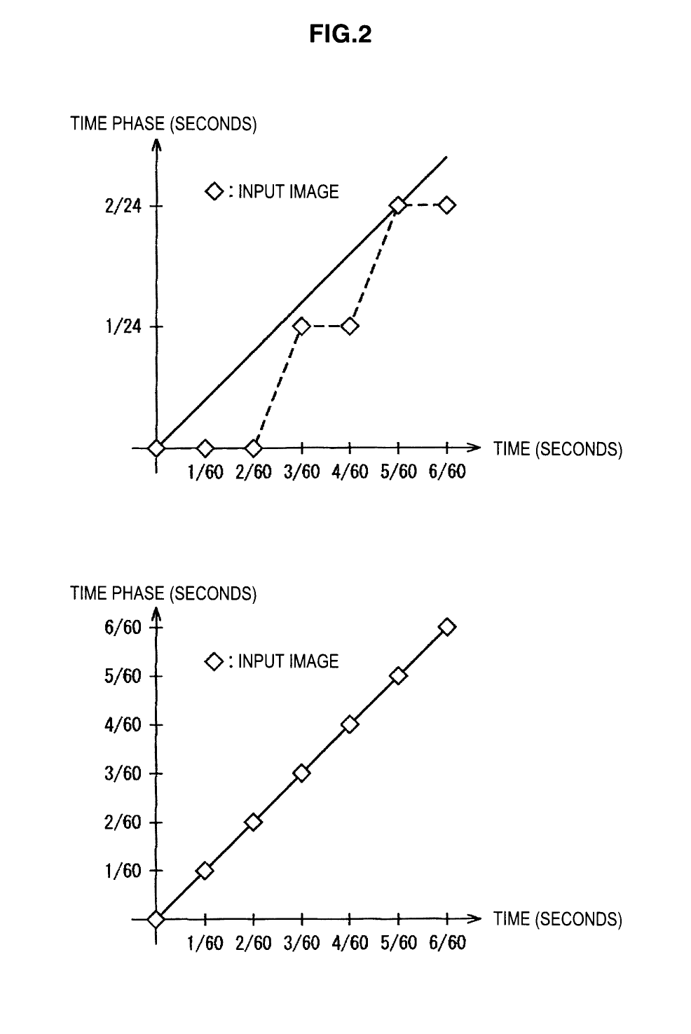

FIG. 3 is a block diagram showing a functional configuration example of one embodiment of an image processing device to which the present technology is applied;

FIG. 4 is a block diagram showing a functional configuration example of a motion detection portion;

FIG. 5 is a diagram showing an example of screen division;

FIG. 6 is a block diagram showing another functional configuration example of the motion detection portion;

FIG. 7 is a block diagram showing a functional configuration example of a frame frequency estimation portion;

FIG. 8 is a flowchart illustrating frame frequency estimation processing;

FIG. 9 is a flowchart illustrating pull-down cycle detection processing;

FIG. 10 is a diagram showing motion history examples;

FIG. 11 is a flowchart illustrating frame rate conversion processing;

FIG. 12 is a diagram illustrating an interpolation phase;

FIG. 13 is a diagram illustrating an example of motion compensation processing; and

FIG. 14 is a block diagram showing a hardware configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the embodiments of the present technology will be explained with reference to the drawings. Note that the explanation will be made in the following order.

1. Functional configuration of image processing device

2. Frame frequency estimation processing

3. Frame rate conversion processing

1. Functional Configuration of Image Processing Device

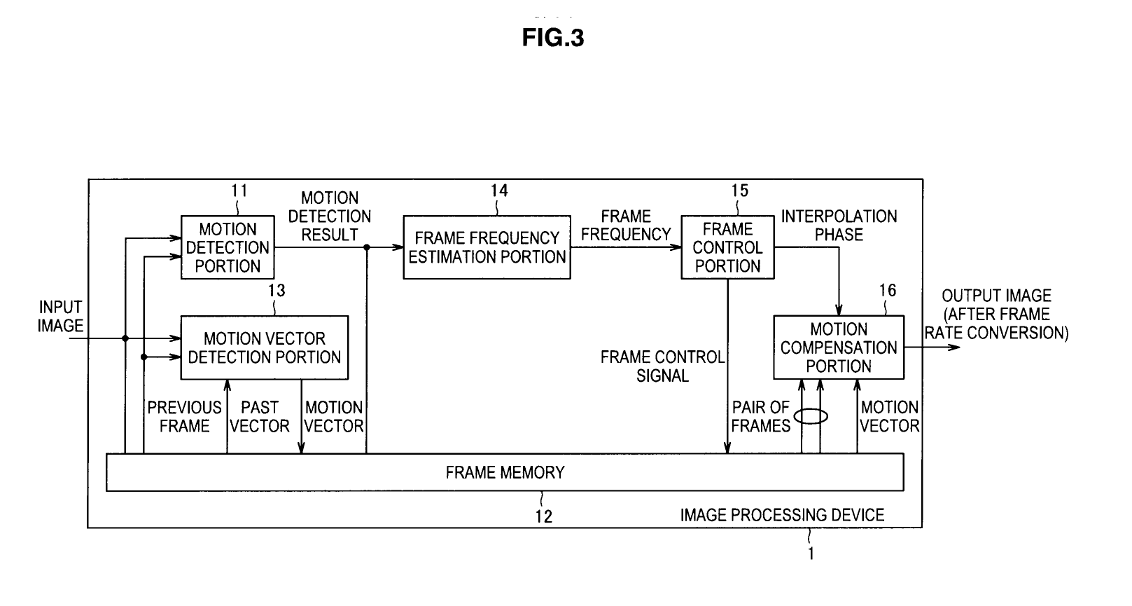

FIG. 3 shows a configuration of one embodiment of an image processing device to which the present technology is applied.

An image processing device 1 shown in FIG. 3 performs frame rate conversion using a motion vector, on an input image as a progressive signal, and supplies an output image after the frame rate conversion to a display device (not shown in the drawings), such as a liquid crystal display or the like. The frame rate of the output image is set in advance or is set by a user.

The image processing device 1 shown in FIG. 3 is formed by a motion detection portion 11, a frame memory 12, a motion vector detection portion 13, a frame frequency estimation portion 14, a frame control portion 15 and a motion compensation portion 16.

The motion detection portion 11 detects, for each frame, whether or not there is motion between an input image frame (hereinafter also referred to as a current frame) that is input to the image processing device 1 and an input image frame (hereinafter also referred to as a previous frame) that has been input one frame previously. The motion detection portion 11 supplies a detection result indicating whether or not there is detected motion, to the frame memory 12 and to the frame frequency estimation portion 14.

Functional Configuration Example of Motion Detection Portion

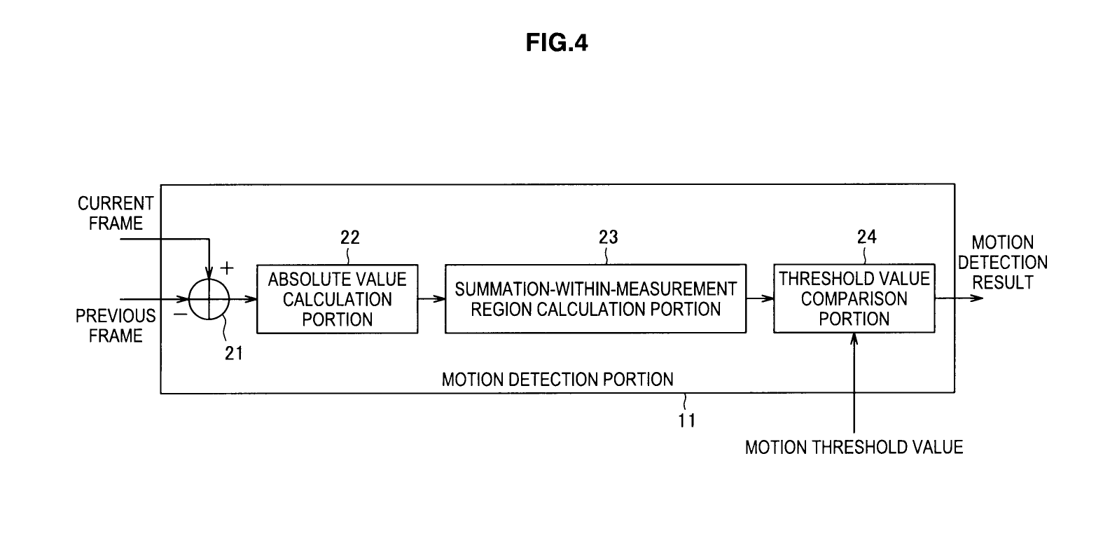

Here, a functional configuration example of the motion detection portion 11 will be explained in detail with reference to FIG. 4.

The motion detection portion 11 shown in FIG. 4 is formed by an operation portion 21, an absolute value calculation portion 22, a summation-within-measurement region calculation portion 23, and a threshold value comparison portion 24.

The operation portion 21 calculates, for each pixel, a difference between a luminance value of the current frame and a luminance value of the previous frame, and supplies the difference to the absolute value calculation portion 22. The absolute value calculation portion 22 calculates an absolute value (a frame difference absolute value) of the luminance value difference between the frames for each pixel that is supplied from the operation portion 21, and supplies the absolute value to the summation-within-measurement region calculation portion 23.

Within a measurement region specified by the user, the summation-within-measurement region calculation portion 23 calculates a summation (a frame difference absolute value sum) of the frame difference absolute value for each pixel that is supplied from the absolute value calculation portion 22, and supplies the frame difference absolute value sum to the threshold value comparison portion 24. The threshold value comparison portion 24 compares the frame difference absolute value sum that is supplied from the summation-within-measurement region calculation portion 23 with a predetermined threshold value (a motion threshold value). The motion threshold value may be set in advance or may be set by the user.

When the frame difference absolute value sum is larger than the motion threshold value, the threshold value comparison portion 24 determines that there is motion between the current frame and the previous frame, and outputs a motion detection result indicating this determination. On the other hand, when the frame difference absolute value sum is smaller than the motion threshold value, the threshold value comparison portion 24 determines that there is no motion between the current frame and the previous frame, and outputs a motion detection result indicating this determination.

In this way, the motion detection portion 11 outputs a motion detection result indicating whether or not there is motion between the frames.

It should be noted that, in the motion detection portion 11 shown in FIG. 4, when there is motion only in a part of the input image or when the input image is displayed on two screens and there is motion only on one of the two screens, the motion with respect to the whole input image becomes relatively small. In such a case, it may be determined that there is no motion regardless of the fact that there is motion.

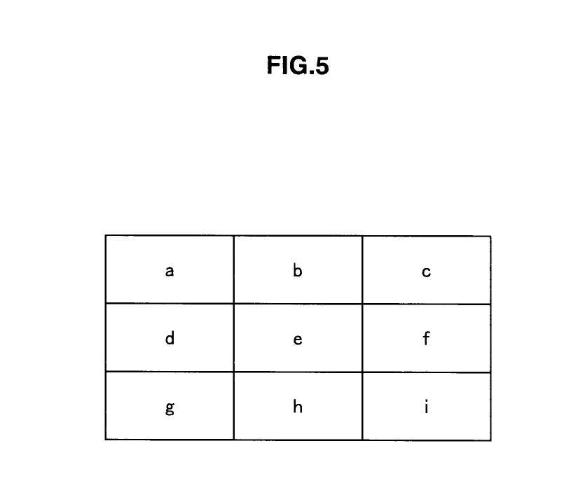

To address this, as shown in FIG. 5, the input image may be divided into nine regions, i.e., a to i regions, and whether or not there is motion may be detected in each of the nine regions.

Another Functional Configuration Example of Motion Detection Portion

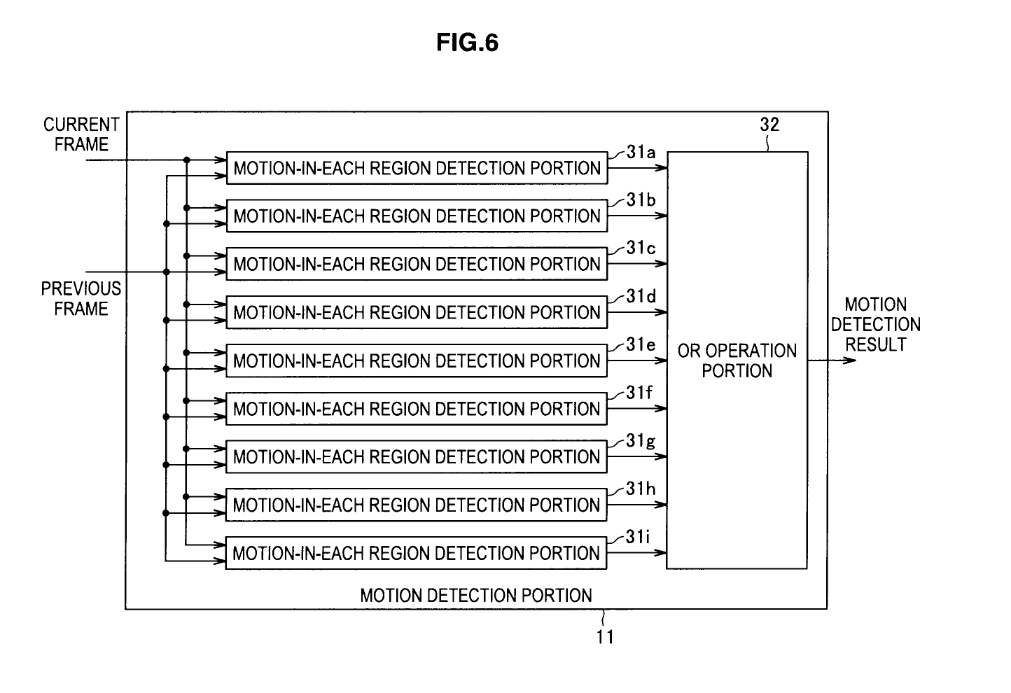

FIG. 6 shows a functional configuration example of the motion detection portion 11 that is adapted to detect whether or not there is motion in each of the divided nine regions of the input image shown in FIG. 5.

The motion detection portion 11 shown in FIG. 6 is formed by motion-in-each region detection portions 31a to 31i, and an OR operation portion 32.

Each of the motion-in-each region detection portions 31a to 31i is configured in a similar way to the motion detection portion 11 explained with reference to FIG. 4, and detects whether or not there is a motion in each of the regions a to i of the input image shown in FIG. 5. More specifically, each of the motion-in-each region detection portions 31a to 31i calculates a frame difference absolute value sum for each of the regions a to i of the input image, and compares the frame difference absolute value sum with the motion threshold value. Then, each of the motion-in-each region detection portions 31a to 31i supplies an obtained motion detection result to the OR operation portion 32.

The OR operation portion 32 performs an OR operation on the motion detection result from each of the motion-in-each region detection portions 31a to 31i, and outputs a result of the OR operation as a motion detection result of the whole input image (frame). More specifically, when at least one of the motion detection results from the motion-in-each region detection portions 31a to 31i indicates that there is motion, the OR operation portion 32 outputs a motion detection result indicating that there is motion with respect to the whole input image.

With this type of configuration, even when there is motion only in a part of the input image or even when the input image is displayed on two screens and there is motion only on one of the two screens, whether or not there is motion is determined correctly.

Note that the method for dividing the input image is not limited to the method shown in FIG. 5. Further, the configuration of the motion detection portion 11 can be changed as appropriate in accordance with the method for dividing the input image.

The explanation returns to FIG. 3. The frame memory 12 is provided with a frame memory controller (not shown in the drawings). Under control of the frame memory controller, the frame memory 12 stores each of frames of the input image, a motion detection result from the motion detection portion 11, and a motion vector from the motion vector detection portion 13. The frames of the input image stored in the frame memory 12 are read as appropriate by the motion detection portion 11, the motion vector detection portion 13 and the motion compensation portion 16. The motion vector stored in the frame memory 12 is read as appropriate by the motion vector detection portion 13 and the motion compensation portion 16.

The motion vector detection portion 13 detects a motion vector of the input image for each frame, using the current frame input to the image processing device 1 and the previous frame stored in the frame memory 12, and supplies the motion vector to the frame memory 12.

The frame frequency estimation portion 14 holds motion detection results from the motion detection portion 11 for a plurality of frames. When the input image is a pull-down image, the frame frequency estimation portion 14 estimates, based on the motion detection results, a frame frequency of the original image before the pull-down has been performed on the input image. The frame frequency estimation portion 14 supplies the estimated frame frequency of the original image to the frame control portion 15.

Functional Configuration Example of Frame Frequency Estimation Portion

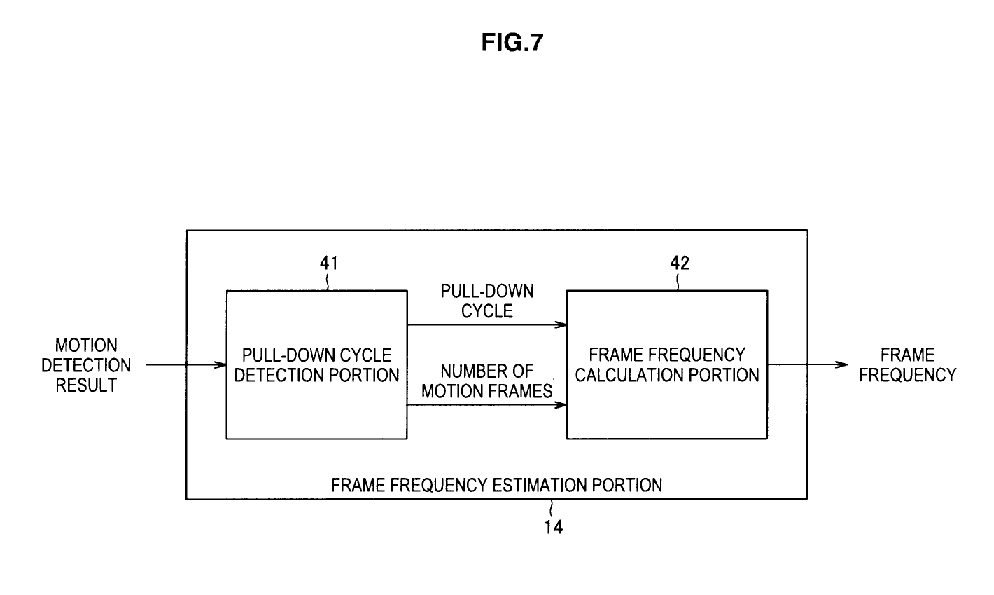

Here, a functional configuration example of the frame frequency estimation portion 14 will be explained in detail with reference to FIG. 7.

The frame frequency estimation portion 14 shown in FIG. 7 is formed by a pull-down cycle detection portion 41 and a frame frequency calculation portion 42.

When the input image is an image on which the pull-down has been performed using a predetermined pull-down pattern, the pull-down cycle detection portion 41 detects the pull-down pattern based on the motion detection results from the motion detection portion 11. Specifically, based on the motion detection results from the motion detection portion 11, the pull-down cycle detection portion 41 detects a pull-down cycle that is a cycle of frames in which the pull-down pattern is repeated. Further, in the detected pull-down cycle, the pull-down cycle detection portion 41 counts the number of motion frames that represents the number of motions between the input image frames. Further, the pull-down cycle detection portion 41 identifies the frame frequency of the input image based on the motion detection results from the motion detection portion 11. The pull-down cycle detection portion 41 supplies the pull-down cycle and the number of motion frames to the frame frequency calculation portion 42, together with the frame frequency of the input image.

The frame frequency calculation portion 42 calculates a frame frequency of the original image before the pull-down has been performed on the input image, based on the pull-down pattern of the input image that is detected by the pull-down cycle detection portion 41 and on the frame frequency of the input image. Specifically, the frame frequency calculation portion 42 calculates the frame frequency of the original image based on the pull-down cycle, the number of motion frames, and the frame frequency of the input image that are supplied from the pull-down cycle detection portion 41.

The explanation returns to FIG. 3. Based on the frame frequency of the original image from the frame frequency estimation portion 14 and on a frame frequency of an output image that has been set in advance or that has been set by the user, the frame control portion 15 generates a frame control signal that specifies two original image frames (hereinafter also referred to as a pair of original image frames or a pair of frames) that are used in motion compensation processing by the motion compensation portion 16, and supplies the frame control signal to the frame memory 12. Further, the frame control portion 15 calculates an interpolation phase (which represents a time position between the pair of original image frames) of an interpolated frame generated in the motion compensation processing by the motion compensation portion 16, and supplies the interpolation phase to the motion compensation portion 16. In this way, the frame control portion 15 controls the motion compensation processing by the motion compensation portion 16.

The motion compensation portion 16 performs motion compensation based on: the pair of original image frames that are specified by the frame control signal generated by the frame control portion 15, from among the input image frames stored in the frame memory 12; and the motion vectors of the input images corresponding to the pair of frames. Then, the motion compensation portion 16 generates an interpolated frame image of the original image, using the interpolation phase from the frame control portion 15.

The image obtained as a result of the motion compensation processing by the motion compensation portion 16 is supplied, as an output image on which the frame rate conversion has been performed, to a display device (not shown in the drawings), such as a liquid crystal display or the like, and the output image is displayed.

2. Frame Frequency Estimation Processing

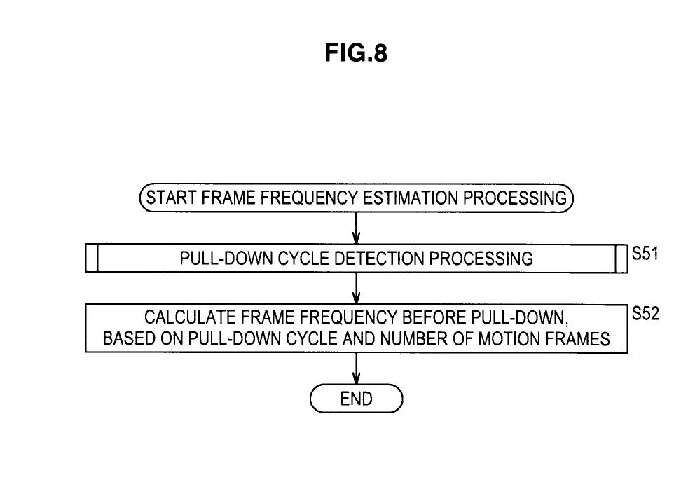

Next, frame frequency estimation processing by the image processing device 1 will be explained with reference to FIG. 8. The frame frequency estimation processing shown in FIG. 8 is started when the motion detection results from the motion detection portion 11 are held for a predetermined number of frames by the frame frequency estimation portion 14.

At step S51, the pull-down cycle detection portion 41 performs pull-down cycle detection processing, and detects a pull-down cycle of the input image. At the same time, the pull-down cycle detection portion 41 counts the number of motion frames of the input image.

Example of Pull-Down Cycle Detection Processing

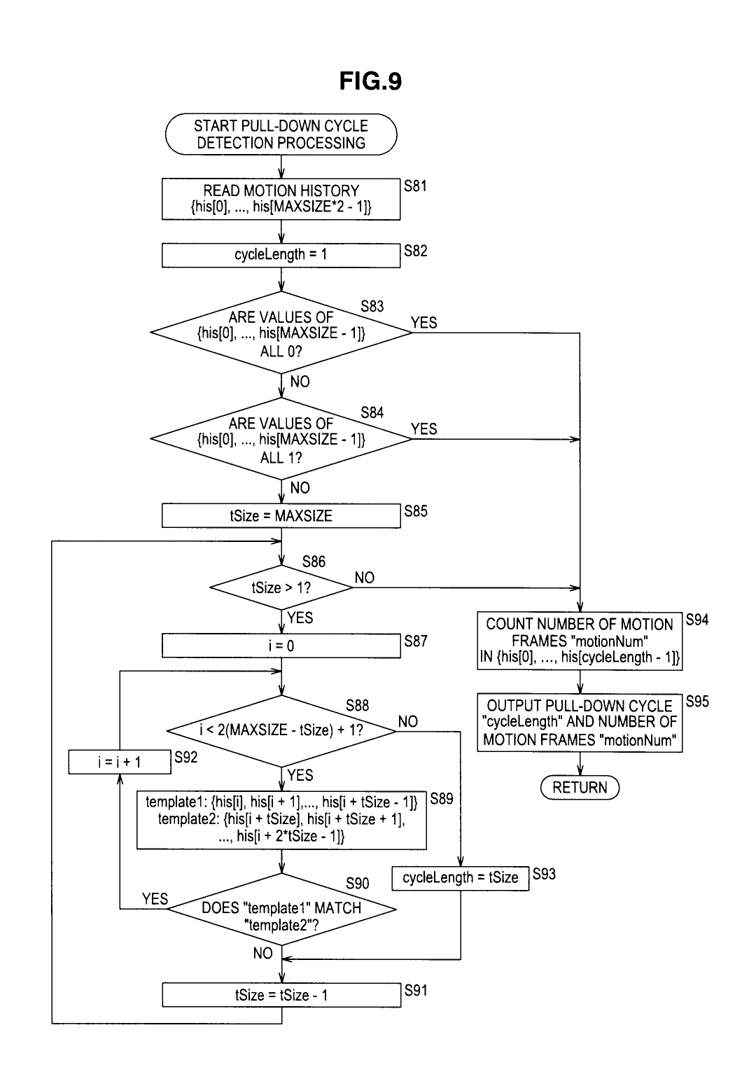

Here, the pull-down cycle detection processing by the pull-down cycle detection portion 41 will be explained with reference to a flowchart shown in FIG. 9.

At step S81, the pull-down cycle detection portion 41 reads motion detection results {his[0], . . . , his[MAXSIZE*2−1]} as a motion history corresponding to the predetermined number of frames of the input image held inside the pull-down cycle detection portion 41.

Here, “his[0]” indicates a motion detection result with respect to the current frame and the previous frame, and “his[k]” indicates a motion detection result with respect to a frame that is k frames prior to the current frame and a frame that is k frames prior to the previous frame. Further, “MAXSIZE” indicates a maximum pull-down cycle that is set by the user in advance. Note that “his[k]” takes a value of 1 or 0, where “his[k]=1” indicates that there is motion as the motion detection result, and “his[k]=0” indicates that there is no motion as the motion detection result.

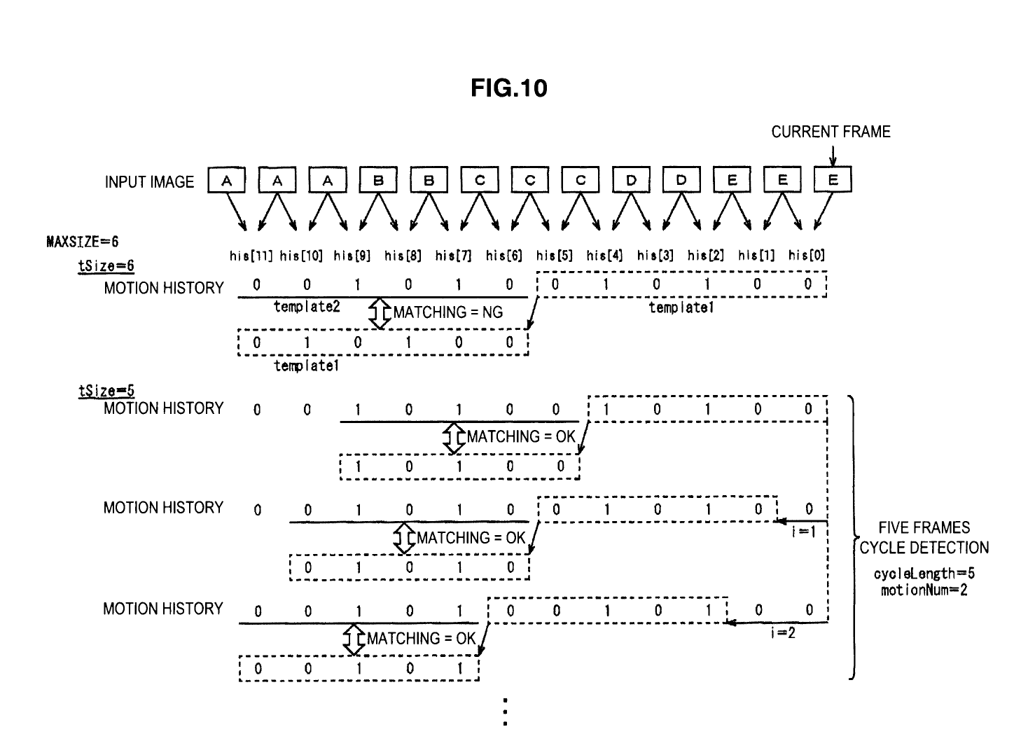

FIG. 10 is a diagram showing motion history examples. In FIG. 10, of the input image frames, the right-most frame denoted by “E” is the current frame. Past frames are located to the left of the current frame. Note that the input images shown in FIG. 10 are images on which 3-2 pull-down processing has been performed.

In FIG. 10, “MAXSIZE=6” is set. Therefore, at step S81, the motion history {his[0], . . . , his[11]} is read, and values of the read motion history are 0, 0, 1, 0, 1, 0, 0, 1, 0, 1, 0, 0 in that order from “his[0]”.

At step S82, the pull-down cycle detection portion 41 sets to 1 the value of a pull-down cycle “cycleLength” to be finally detected.

At step S83, the pull-down cycle detection portion 41 determines whether or not the values of the read motion history {his[0], . . . , his[MAXSIZE−1]} are all 0. In the example shown in FIG. 10, the values of the motion history {his[0], . . . , his[MAXSIZE−1]} are not all 0. Therefore, the processing proceeds to step S84.

At step S84, the pull-down cycle detection portion 41 determines whether or not the values of the read motion history {his[0], . . . , his[MAXSIZE−1]} are all 1. In the example shown in FIG. 10, the values of the motion history {his[0], his[MAXSIZE−1]} are not all 1. Therefore, the processing proceeds to step S85.

At step S85, the pull-down cycle detection portion 41 sets “tSize=MAXSIZE”, where “tSize” is a parameter (hereinafter referred to as a candidate pull-down cycle) that becomes a candidate for the pull-down cycle. In summary, in the example shown in FIG. 10, first, “tSize=6” is set.

At step S86, the pull-down cycle detection portion 41 determines whether or not “tSize>1” is established. When it is determined at step S86 that “tSize>1” is established, the processing proceeds to step S87 and a parameter i is set to “i=0”.

At step S87, the pull-down cycle detection portion 41 determines whether or not “i<2(MAXSIZE−tSize)+1” is established. In the example shown in FIG. 10, the value of “2(MAXSIZE−tSize)+1” becomes equal to 1, and it is determined that “i<2(MAXSIZE−tSize)+1” is established. Therefore, the processing proceeds to step S89.

At step S89, the pull-down cycle detection portion 41 sets, as templates, motion histories corresponding to the candidate pull-down cycle, “tSize”. Specifically, the motion history {his[i], his[i+1], . . . , his[i+tSize-1]} is set as a first template “template1”, and a motion history {his[i+tSize], his[i+tSize+1], . . . , his[i+2*tSize-1]} is set as a second template “template2”. More specifically, in FIG. 10, first, {his[0], his[1], . . . , his[5]} is set as the first template “template1”, and {his[6], his[7], . . . , his[11]} is set as the second template “template2”.

Then, at step S90, the pull-down cycle detection portion 41 determines whether or not the first template “template1” matches the second template “template2”. In the example shown in FIG. 10, the first template is “template1={0, 0, 1, 0, 1, 0}” and the second template is “template2={0, 1, 0, 1, 0, 0}”. Therefore, they do not match each other, and the processing proceeds to step S91.

At step S91, the pull-down cycle detection portion 41 sets “tSize=tSize−1” as the candidate pull-down cycle “tSize”, and the processing returns to step S86. More specifically, in the example shown in FIG. 10, “tSize=5” is set and the processing from step S86 onwards is performed a second time.

In the example shown in FIG. 10, at the second time of step S89, the motion history {his[0], his[1], . . . , his[4]} is set as the first template “template1”, and the motion history {his[5], his[7], . . . , his[9]} is set as the second template “template2”. Then, at the second time of step S90, the first template “template1={0, 0, 1, 0, 1}” matches the second template “template2={0, 0, 1, 0, 1}”, and the processing proceeds to step S92.

At step S92, the pull-down cycle detection portion 41 sets the parameter i to “i=i+1”, and the processing returns to step S88. More specifically, in the example shown in FIG. 10, “i=1” is set, and the processing from step S88 onwards is performed a third time.

In the example shown in FIG. 10, at the third time of step S89, the motion history {his[1], his[2], . . . , his[5]} is set as the first template “template1”, and the motion history {his[6], his[7], . . . , his[10]} is set as the second template “template2”. Then, at the third time of step S90, the first template “template1={0, 1, 0, 1, 0}” matches the second template “template2={0, 1, 0, 1, 0}”, and the processing proceeds to the second time of step S92.

In the example shown in FIG. 10, “i=2” is set at the second time of step S92, and the processing from step S88 onwards is performed a fourth time.

More specifically, at the fourth time of step S89, the motion history {his[2], his[3], . . . , his[6]} is set as the first template “template1”, and the motion history {his[7], his[8], . . . , his[11]} is set as the second template “template2”. Then, at the fourth time of step S90, the first template “template1={1, 0, 1, 0, 0}” matches the second template “template2={1, 0, 1, 0, 0}”, and the processing proceeds to the third time of step S92.

In the example shown in FIG. 10, “i=3” is set at the third time of step S92, and the processing from step S88 onwards is performed a fifth time. At this time, the value of “2(MAXSIZE−tSize)+1” becomes equal to 3. Therefore, at the fifth time of step S88, it is determined that “i<2(MAXSIZE−tSize)+1” is not established, and the processing proceeds to step S93.

At step S93, the pull-down cycle detection portion 41 sets “cycleLength=tSize”. More specifically, in the above-described example shown in FIG. 10, “cycleLength=5” is set and the processing returns to step S91. In the example shown in FIG. 10, “tSize=4” is set at step S91 and the processing from step S86 onwards is repeated. After “tSize=1” is finally set, it is determined at step S86 that “tSize>1” is not established and the processing proceeds to step S94.

At step S94, the pull-down cycle detection portion 41 counts the number of motion frames “motionNum”, which is the number of frames with motion in the motion history {his[0], . . . , his[cycleLength-1]}. More specifically, in the example shown in FIG. 10, the number of “1” in the motion history {his[0], his[4]}={0, 0, 1, 0, 1} is counted and thus “motionNum=2” is set.

Then, at step S95, the pull-down cycle detection portion 41 outputs the pull-down cycle “cycleLength” and the number of motion frames “motionNum”, and the processing ends. More specifically, in the example shown in FIG. 10, “cycleLength=5” is output as the pull-down cycle and “motionNum=2” is output as the number of motion frames. In this way, for the input image which has undergone the 3-2 pull-down processing, the pull-down cycle is set to 5 and the number of motion frames is set to 2.

On the other hand, when it is determined at step S83 that the values of the motion history {his[0], . . . , his[MAXSIZE]} are all 0, namely, when there is no motion in the input image, the processing proceeds to step S94 and step S95 and “cycle Length=1” and “motionNum=0” are set.

Further, at step S84, when it is determined that the values of the motion history {his[0], his[MAXSIZE]} are all 1, namely, when the input images are video materials (original images) rather than the images on which the pull-down processing has been performed using the predetermined pull-down pattern, the processing proceeds to step S94 and step S95 and “cycle Length=1” and “motionNum=1” are set.

In this way, the maximum pull-down cycle “MAXSIZE” specified by the user is used as an initial value of the candidate pull-down cycle. The motion history corresponding to the candidate pull-down cycle is used as the first template “template1” and the motion history obtained by displacing the first template to the past by one candidate pull-down cycle is used as the second template “template 2”. Then, the two templates are compared.

After comparing the templates that correspond to the candidate pull-down cycle, the candidate pull-down cycle is reduced (the processing at step S91) and similar template comparison processing is repeated. Finally, a minimum candidate pull-down cycle, in which the two templates match each other, is output. Thus, when the input images are images on which 2-2 pull-down processing has been performed, the motion history is denoted as “1, 0, 1, 0, 1, 0, . . . ” and the candidate pull-down cycle can be denoted as “ . . . , 6, 4, 2”. As a result, 2 is output as the minimum candidate pull-down cycle.

Note that, in the above-described processing, the smaller the pull-down cycle, the larger the number of times the two templates are compared. However, in order to reduce the operation load, a limitation may be imposed on the number of times the templates are compared in one candidate pull-down cycle.

Returning to the flowchart shown in FIG. 8, the pull-down cycle “cycleLength” and the number of motion frames “motionNum” obtained at step S51 are supplied to the frame frequency calculation portion 42. At this time, the pull-down cycle detection portion 41 identifies the frame frequency of the input image based on the motion detection results from the motion detection portion 11, and supplies the identified frame frequency to the frame frequency calculation portion 42.

Then, at step S52, the frame frequency calculation portion 42 calculates the frame frequency of the original image based on the pull-down cycle “cycleLength”, the number of motion frames “motionNum”, and the frame frequency of the input image that are supplied from the pull-down cycle detection portion 41. Here, if the frame frequency of the input image is denoted by “f_in”, the frame frequency of the original image “f_org” before the pull-down is given by the following Expression (1).

f_org=f_in×(motionNum/cycleLength) (1)

For example, when the input image is the image which has undergone the 3-2 pull-down processing and whose frame frequency is fin=60 Hz, the pull-down cycle “cycleLength” is equal to 5 and the number of motion frames “motionNum” is equal to 2, as explained with reference to FIG. 10. Therefore, according to Expression (1), the frame frequency of the original image “f_org” before the pull-down is given as “f_org=60×(2/5)=24 Hz”. The frame frequency of the original image that is calculated (estimated) in this way is supplied to the frame control portion 15.

According to the above-described processing, with respect to the input image that has undergone the pull-down processing with a given pull-down pattern, it is possible to estimate the frame frequency of the original image before the pull-down has been performed on the input image.

Particularly, it is not necessary to hold all the existing pull-down patterns in a table, and it is therefore possible to estimate the frame frequency of the original image with simple control at a low cost. In addition, it is also possible to deal with a pull-down pattern that does not currently exist, and it is therefore possible to improve future scalability.

3. Frame Rate Conversion Processing

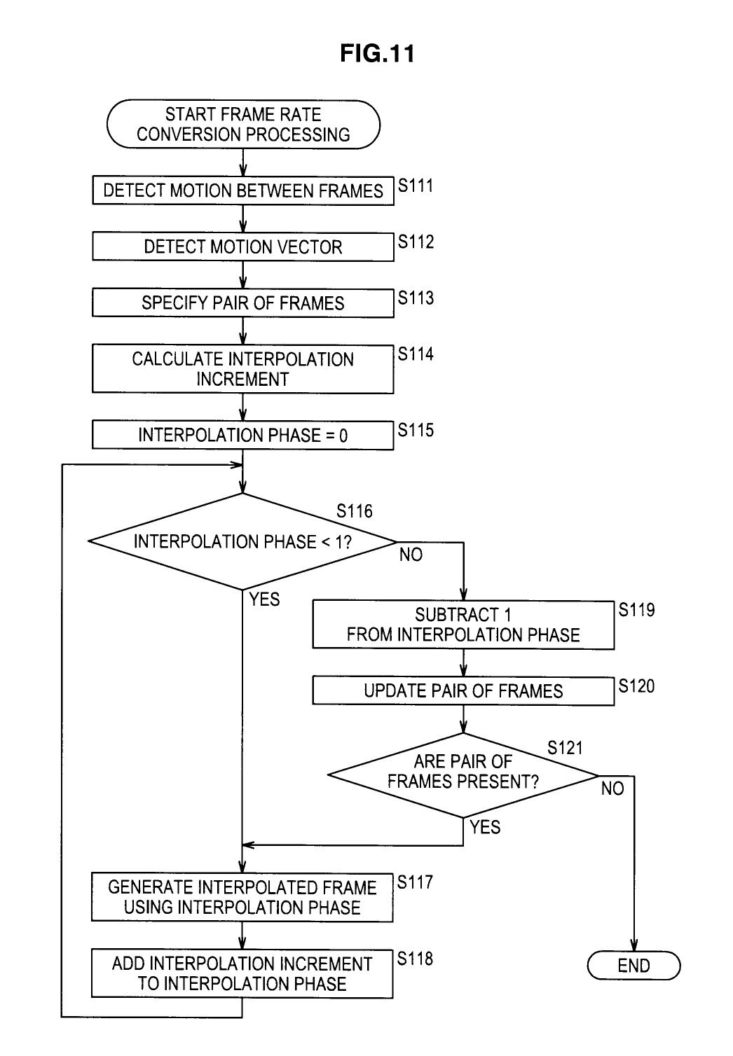

Next, frame rate conversion processing by the information processing device 1 will be explained with reference to a flowchart shown in FIG. 11. The frame rate conversion processing uses the frame frequency of the original image that has been estimated by the above-described frame frequency estimation processing. The frame rate conversion processing shown in FIG. 11 is performed after the frame frequency estimation processing shown in FIG. 8 is completed.

At step S111, the motion detection portion 11 detects whether or not there is motion between the current frame that is input to the image processing device 1 and the previous frame stored in the frame memory 12, and supplies a motion detection result to the frame memory 12.

At step S112, the motion vector detection portion 13 detects a motion vector of the input image for each frame, using the current frame that is input to the image processing device 1 and the previous frame stored in the frame memory 12, and supplies the detected motion vector to the frame memory 12. Note that the detection of the motion vector is performed, for example, by a block matching method, a gradient method, a phase correlation method or the like.

At step S113, the frame control portion 15 generates a frame control signal that specifies a pair of original image frames that are used in the motion compensation processing by the motion compensation portion 16, and supplies the frame control signal to the frame memory 12.

At step S114, based on the frame frequency of the original image that is supplied from the frame frequency estimation portion 14 and on the frame frequency of the output image, the frame control portion 15 calculates an interpolation increment that represents an interval in which the interpolated frames that are generated in the motion compensation processing by the motion compensation portion 16 are temporally located between the pair of original image frames. Here, if the frame frequency of the output image is denoted by “f_out”, an interpolation increment “w” is given by the following Expression (2).

w=f_org/f_out (2)

For example, when the input image is the image which has undergone the 3-2 pull-down processing and whose frame frequency is “fin=60 Hz”, the frame frequency of the original image “f_org” becomes equal to 24 Hz, as described above. Here, if it is assumed that the frame frequency of the output image is “f_out=120 Hz”, the interpolation increment “w” is calculated according to Expression (2) in the following manner: w=24/120=0.2. This indicates that, if the interval between the pair of original image frames is taken as one unit time, the interpolated frames are arranged (output) at a time interval of 0.2.

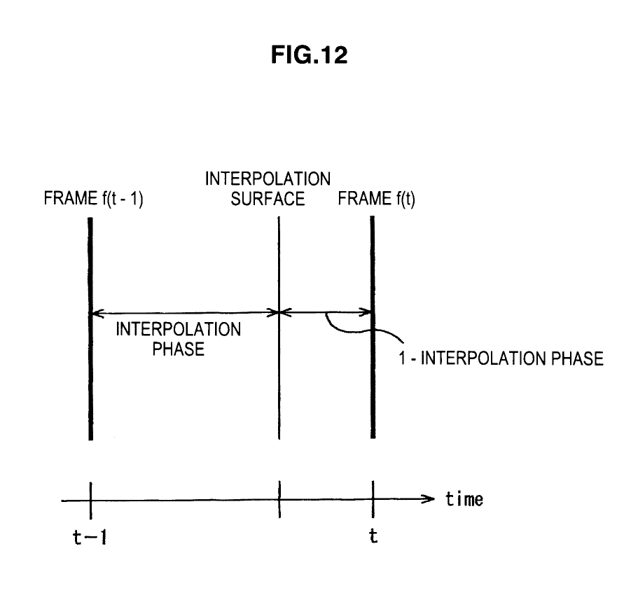

At step S115, the frame control portion 15 sets the interpolation phase, which represents a time position between the pair of original image frames, to 0 and supplies the interpolation phase to the motion compensation portion 16. As shown in FIG. 12, between an original image frame f(t−1) at a time t−1 and an original image frame f(t) at a time t, the interpolation phase represents a time position of the interpolated frame from the frame f(t−1). The interpolation phase changes, for each of the interpolated frames, at the interval of the interpolation increment “w” from the frame f(t−1). In FIG. 12, the interpolated frame is arranged at the time position denoted by an interpolation surface.

At step S116, the frame control portion 15 determines whether or not the interpolation phase is less than 1. When it is determined at step S116 that the interpolation phase is less than 1, the processing proceeds to step S117. The motion compensation portion 16 performs motion compensation based on the pair of original image frames, which are specified by the frame control portion 15 and stored in the frame memory 12, and on the motion vectors of the input images corresponding to the pair of original image frames, and generates an interpolated frame, using the interpolation phase at the time when it is supplied from the frame control portion 15.

At step S118, the frame control portion 15 adds the interpolation increment to the interpolation phase, and the processing returns to step S116. The processing from step S116 to step S118, namely, the motion compensation processing of the pair of original image frames specified by the frame control portion 15, is repeated until it is determined at step S116 that the interpolation phase is not less than 1.

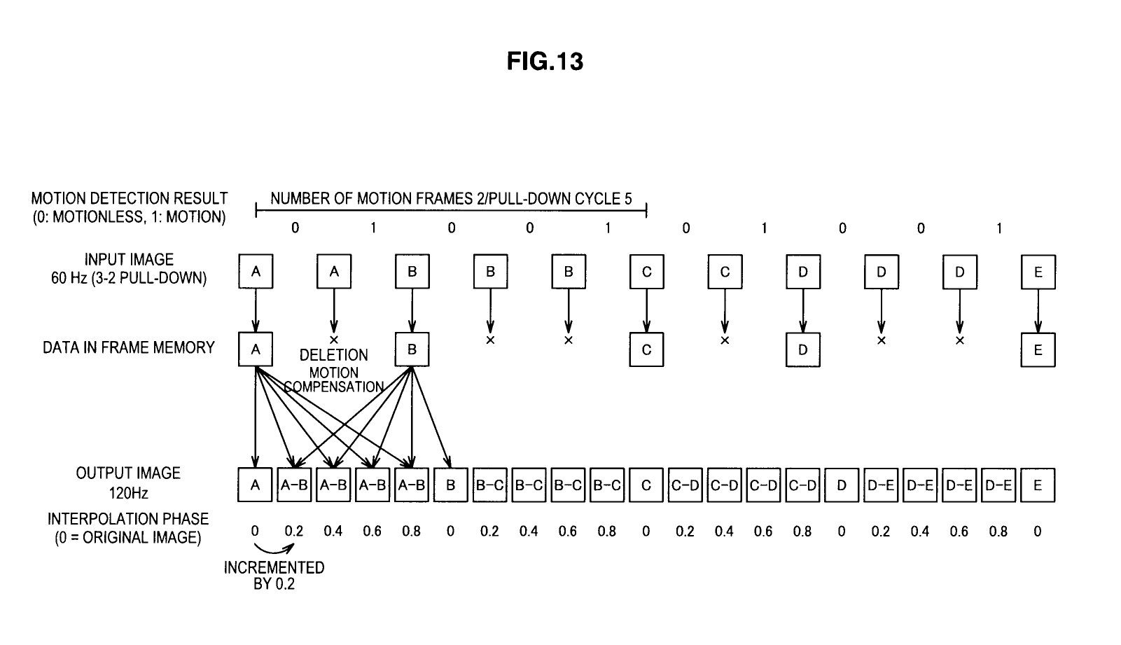

Here, an example of the motion compensation processing of the pair of original image frames will be explained with reference to FIG. 13. In FIG. 13, the input images are images that have undergone the 3-2 pull-down processing and whose frame frequency is 60 Hz, and the output images are images with a frame frequency of 120 Hz.

First, in the input images, focusing on five frames A, A, B, B and B that are included in the pull-down cycle (cycleLength=5), the frame control portion 15 generates a frame control signal that specifies the frames A and B as the pair of original image frames. At this time, the input images are stored in the frame memory 12 for each frame. However, under control of a frame controller (not shown in the drawings), based on motion detection results that are supplied from the motion detection portion 11, only the frames for which motion has been detected may be stored. The frame for which no motion has been detected (for example, the second frame A of the input image frames shown in FIG. 13) may be deleted and its memory area may be overwritten by the next input image (the frame B). By doing this, it is possible to save a memory capacity of the frame memory 12.

When the frames A and B are specified as the pair of original image frames, the motion compensation portion 16 outputs the frame A with an interpolation phase of 0. After that, when 0.2 is added to the interpolation phase, the motion compensation portion 16 outputs an interpolated frame A-B obtained by performing the motion compensation with an interpolation phase of 0.2 based on the frames A and B and on motion vectors of the frames A and B. After that, when 0.2 is further added to the interpolation phase, the motion compensation portion 16 outputs the interpolated frame A-B with an interpolation phase of 0.4. In this way, the interpolation phase is added by 0.2 at a time. When the interpolation phase reaches 1, it is determined at step S116 of the flowchart shown in FIG. 11 that the interpolation phase is not less than 1.

Returning to the flowchart shown in FIG. 11, when it is determined at step S116 that the interpolation phase is not less than 1, the processing proceeds to step S119 and the frame control portion 15 subtracts 1 from the interpolation phase. That is, the interpolation phase becomes equal to 0.

Then, at step S120, the frame control portion 15 generates a frame control signal to update the pair of frames and supplies the frame control signal to the frame memory 12. Based on the frame control signal, the motion vectors of the input images corresponding to the pair of frames that are used for motion compensation are updated together with the pair of frames.

At step S121, the frame control portion 15 determines whether or not the pair of frames that have not undergone the motion compensation processing are present in the frame memory 12. When it is determined that the pair of frames that have not undergone the motion compensation processing are present in the frame memory 12, the processing returns to step S117 and the processing from step S116 to step S118, namely, the motion compensation processing, is repeated for the updated pair of frames.

More specifically, when the frames B and C are specified as the pair of original image frames as shown in FIG. 13, the motion compensation portion 16 outputs an image B with an interpolation phase of 0. After that, when 0.2 is added to the interpolation phase, the motion compensation portion 16 outputs an interpolated frame B-C obtained by performing the motion compensation with an interpolation phase of 0.2 based on the frames B and C and on motion vectors of the frames B and C. After that, when 0.2 is further added to the interpolation phase, the motion compensation portion 16 outputs the interpolated frame B-C with an interpolation phase of 0.4. The interpolation phase is added by 0.2 at a time until the interpolation phase reaches 1, and the interpolated frames are output.

In this way, from among the input images which have undergone the 3-2 pull-down processing and whose frame frequency is 60 Hz, the original images before the pull-down are specified as the images used for the motion compensation processing, and the interpolated frames are generated based on the original images (the pair of frames). Thus, output images with a frame frequency of 120 Hz are output. Note that, when the interpolation phase is 0, the original images are output.

On the other hand, when it is determined at step S121 that the pair of frames that have not undergone the motion compensation processing are not present in the frame memory 12, the processing ends.

With the above-described processing, when the frame rate conversion is performed on the input images that have undergone the pull-down processing with a predetermined pull-down pattern, the frame frequency of the original images before the pull-down is estimated. Therefore, it is possible to perform the motion compensation based on the original images before the pull-down and it is possible to generate the interpolated frames. More specifically, when the frame rate conversion is performed on the input images of a given pull-down pattern, it is possible to reduce judder with a simple structure without using the table that holds all the existing pull-down patterns.

Note that, when the frame rate of the input images changes by performing the frame frequency estimation processing in parallel with the frame rate conversion processing, namely, when the interpolation increment changes, the frame rate conversion processing may be performed from the beginning. In a case where the image processing device 1 is provided with a structural element that detects a scene change of the input image, when a scene change is detected, the frame rate conversion processing may be performed from the beginning.

In the above description, it is assumed that the frame frequency of the input images is 60 Hz and the frame frequency of the output images is 120 Hz. However, the frame frequencies may be other frame frequencies, respectively.

Further, if the present technology is applied to a stereoscopic image display system that displays a stereoscopic image by outputting a left eye image and a right eye image, even when the left eye image and the right eye image are images that have undergone the pull-down processing with a predetermined pull-down pattern, it is possible to perform motion detection for one of the left eye image and the right eye image and to estimate the frame frequency before the pull-down. Further, the frame frequency before the pull-down may be estimated by performing motion detection for each of the left eye image and the right eye image.

Moreover, in the above description, a luminance value difference between the frames is used for motion detection. However, a sum of absolute values of motion vectors, an average luminance level, a difference in color-difference signals, or the like may be used as long as such feature quantities can be used to detect a difference between the frames. Further, a combination of some of the feature quantities may be used.

Further, in the above description, it is assumed that the input signal input to the image processing device 1 is a progressive signal. However, when an interlaced signal, such as a digital television broadcast signal, is input, an IP converter that performs interlace/progressive (IP) conversion may be provided in a preceding stage so that a progressive signal is input.

Further, when input signals in which different frame frequencies are mixed are input, a pull-down processing portion that performs the pull-down processing with a predetermined pull-down pattern may be provided in a preceding stage so that input signals with a unified frame frequency are input.

The above-described series of processing may be performed by hardware or may be performed by software. When the series of processing is performed by software, a program forming the software is installed into a computer that is incorporated in a dedicated hardware, or installed from a program storage medium into a general-purpose personal computer, for example, that can perform various types of functions by installing various types of programs.

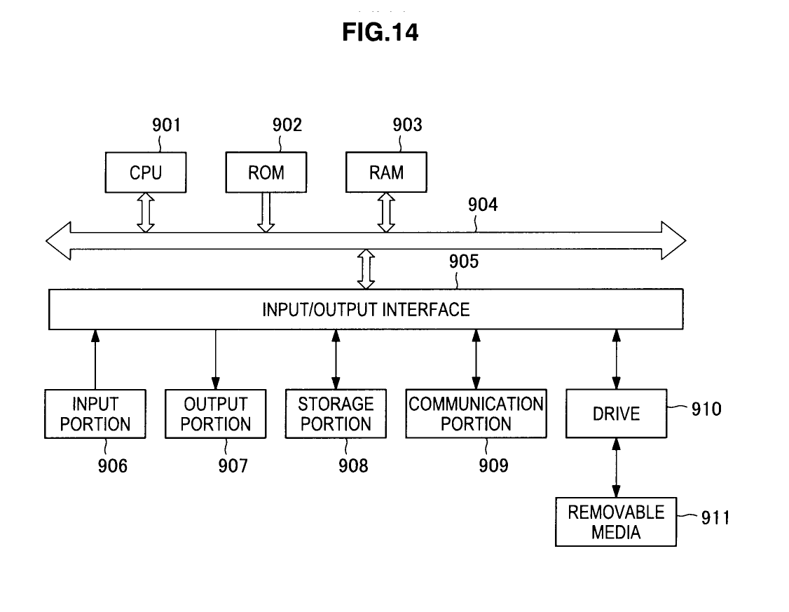

FIG. 14 is a block diagram showing a hardware configuration example of a computer that performs the above-described series of processing using a program.

In the computer, a central processing unit (CPU) 901, a read only memory (ROM) 902 and a random access memory (RAM) 903 are mutually connected by a bus 904.

Further, an input/output interface 905 is connected to the bus 904. Connected to the input/output interface 905 are an input portion 906 formed by a keyboard, a mouse, a microphone and the like, an output portion 907 formed by a display, a speaker and the like, a storage portion 908 formed by a hard disk, a nonvolatile memory and the like, a communication portion 909 formed by a network interface and the like, and a drive 910 that drives a removable media 911 that is a magnetic disk, an optical disk, a magneto-optical disk, or a semiconductor memory etc.

In the computer configured as described above, the CPU 901 loads a program that is stored, for example, in the storage portion 908 onto the RAM 903 via the input/output interface 905 and the bus 904, and executes the program. Thus, the above-described series of processing is performed.

The program executed by the computer (the CPU 901) is recorded in the removable media 911, which is a package media formed by, for example, a magnetic disc (including a flexible disk), an optical disk (a compact disc read only memory (CD-ROM), a digital versatile disc (DVD) or the like), a magneto optical disk, or a semiconductor memory etc. Alternatively, the program is provided via a wired or wireless transmission media, such as a local area network, the Internet and a digital satellite broadcast.

Then, by inserting the removable media 911 into the drive 910, the program can be installed in the storage portion 908 via the input/output interface 905. Further, the program can be received by the communication portion 909 via a wired or wireless transmission media and installed in the storage portion 908. Moreover, the program can be installed in advance in the ROM 902 or the storage portion 908.

Note that the program executed by the computer may be a program that is processed in time series in the order described in this specification, or may be a program that is processed in parallel or at a necessary timing, such as when it is called.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing device including:

a pull-down pattern detection portion that detects a pull-down pattern in an input image on which pull-down has been performed; and

a frame frequency calculation portion that calculates, based on the pull-down pattern and on a first frame frequency that is a frame frequency of the input image, a second frame frequency that is a frame frequency of an original image before the pull-down has been performed on the input image.

(2)

The image processing device according to (1),

wherein the pull-down pattern detection portion detects, based on a pattern of existence and non-existence of motion between frames of the input image, a pull-down cycle that is a frame cycle in which the pull-down pattern is repeated, and counts a number of the frames that represents a number of motions between the frames in the pull-down cycle, and

wherein the frame frequency calculation portion calculates the second frame frequency based on the pull-down cycle, the number of motion frames and the first frame frequency.

(3)

The image processing device according to (1) or (2), further including:

a motion vector detection portion that detects a motion vector between frames of the original image; and

a motion compensation portion that performs motion compensation based on the motion vector, the second frame frequency and a third frame frequency that is a frame frequency of an output image, and generates an interpolated frame of the original image.

(4)

The image processing device according to (3), further including:

an interpolation phase determination portion that calculates, based on the second frame frequency and the third frame frequency, an interpolation phase that represents a time position of the interpolated frame between the frames of the original image,

wherein the motion compensation portion generates the interpolated frame using the interpolation phase between the frames of the original image.

(5)

An image processing method including:

detecting a pull-down pattern in an input image on which pull-down has been performed; and

calculating, based on the pull-down pattern and on a first frame frequency that is a frame frequency of the input image, a second frame frequency that is a frame frequency of an original image before the pull-down has been performed on the input image.

(6)

A program that causes a computer to execute processing including:

detecting a pull-down pattern in an input image on which pull-down has been performed; and

calculating, based on the pull-down pattern and on a first frame frequency that is a frame frequency of the input image, a second frame frequency that is a frame frequency of an original image before the pull-down has been performed on the input image.

The present disclosure contains subject matter related to that disclosed in Japanese Priority Patent Application JP 2011-098391 filed in the Japan Patent Office on Apr. 26, 2011, the entire content of which is hereby incorporated by reference.

What is claimed is:

1. An image processing device comprising:
a pull-down pattern detection portion that detects a pull-down pattern in an input image on which pull-down has been performed; and
a frame frequency calculation portion that calculates, based on the pull-down pattern and on a first frame frequency that is a frame frequency of the input image, a second frame frequency that is a frame frequency of an original image before the pull-down has been performed on the input image.

2. The image processing device according to claim 1,
wherein the pull-down pattern detection portion detects, based on a pattern of existence and non-existence of motion between frames of the input image, a pull-down cycle that is a frame cycle in which the pull-down pattern is repeated, and counts a number of the frames that represents a number of motions between the frames in the pull-down cycle, and
wherein the frame frequency calculation portion calculates the second frame frequency based on the pull-down cycle, the number of motion frames and the first frame frequency.

3. The image processing device according to claim 1, further comprising:
a motion vector detection portion that detects a motion vector between frames of the original image; and
a motion compensation portion that performs motion compensation based on the motion vector, the second frame frequency and a third frame frequency that is a frame frequency of an output image, and generates an interpolated frame of the original image.

4. The image processing device according to claim 3, further comprising:
an interpolation phase determination portion that calculates, based on the second frame frequency and the third frame frequency, an interpolation phase that represents a time position of the interpolated frame between the frames of the original image,
wherein the motion compensation portion generates the interpolated frame using the interpolation phase between the frames of the original image.

5. An image processing method comprising:
detecting a pull-down pattern in an input image on which pull-down has been performed; and
calculating, based on the pull-down pattern and on a first frame frequency that is a frame frequency of the input image, a second frame frequency that is a frame frequency of an original image before the pull-down has been performed on the input image.

6. A program that causes a computer to execute processing comprising:
detecting a pull-down pattern in an input image on which pull-down has been performed; and
calculating, based on the pull-down pattern and on a first frame frequency that is a frame frequency of the input image, a second frame frequency that is a frame frequency of an original image before the pull-down has been performed on the input image.
